(19) United States
(12) Patent Application Publication
(10) Pub. No.: US 2004/0253854 A1
(43) Pub. Date: Dec. 16, 2004

(54) Multipurpose electric adapter

(76) Inventors: Chiu-Shan Lee, Hsintien City (TW); Shen Su-Chen Li, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/457,378

(22) Filed: Jun. 10, 2003

(51) Int. Cl. H01R 4/66

(52) U.S. Cl. 439/106

(57) ABSTRACT

A multipurpose electric adapter is disclosed to include a housing holding two main metal power lead frames and a main metal grounding lead frame near a bottom side and two supplementary power lead frames and a supplementary grounding lead frame respectively connected to the main metal power and grounding lead frames at the top, a back plate fastened to the back side of the housing with the power and grounding prongs disposed in contact with the main metal power and grounding lead frames and extended out of the housing for connection to an electric outlet, and a faceplate covered on the front side of the housing, the faceplate having plug terminal insertion holes corresponding to the main metal power and grounding lead frames and the supplementary metal power and grounding lead frames for receiving any of a variety of electric plugs used in different countries around the world.

### BACKGROUND OF THE INVENTION

1. Field of the Invention

The present invention relates to electric sockets/plugs and, more particularly, to a multipurpose electric adapter for connecting one of a set of electric sockets to one of a set of electric plugs.

2. Description of the Related Art

The development of industry follows with the development of technology. Nowadays, various electronic apparatus have been disclosed, and have appeared on the market. These apparatus use an electric plug or electric socket to obtain power supply. However, an electric plug/socket for use in one country may not suitable for use in another country because different countries may use electric outlets of different specifications. There are DC-AC power adapter, UPS and AVR manufacturers who have their products equipped with a universal socket that fits different electric plugs. However, the known universal sockets cannot fit all countries around the world.

FIGS. 14˜16 show an electric adapter for use to connect one of a set of electric plugs to one of a set of electric sockets according to the prior art. This structure of electric adapter 8 is comprised of a housing 82, a set of metal power lead frames 84 and a metal grounding lead frame 85 mounted in the front side of the housing 82, a plurality of metal contact spring plates 86 respectively mounted in terminal slots 821 in the back side of the housing 82 and disposed in contact with the rear contact faces 841 and 851 of the metal power lead frames 84 and the metal grounding lead frame 85, a face (socket) place 81 covered on the front side of the housing 82, and a back (plug) plate 83 covered on the back side of the housing 82. The back plate 83 comprises two metal power blades 831 and a grounding prong 832 perpendicularly outwardly extended from the outer side. The metal power blades 831 and the grounding prong 832 have a respective inner contact end 8311 or 8321 respectively forced into contact with the metal contact spring plates 86. This design of electric adapter has numerous drawbacks as follows:

1. Because the metal power blades and grounding prong of the back plate are respectively electrically connected to the metal power lead frames and the metal grounding lead frame through the metal contact spring plates, much impedance is produced, resulting in low conducting efficiency.

2. This structure of electric adapter is not durable in use because the metal contact spring plates start to wear quickly with use.

3. Because a number of component parts are used, the assembly process of this structure of electric adapter is complicated.

4. This structure of electric adapter has limited applications because it does not fit electric plugs of South Africa specifications or Australia/New Zealand specifications.

### SUMMARY OF THE INVENTION

The present invention has been accomplished under the circumstances in view, It is the main object of the present invention to provide a multipurpose electric adapter, which fits electric plugs of South Africa specifications as well as Australia/New Zealand specifications and specifications of various other countries. It is another object of the present invention to provide a multipurpose electric adapter, which is easy and inexpensive to manufacture. According to one aspect of the present invention, the multipurpose electric adapter comprises an electrically insulative housing, the housing comprising a plurality of open chambers; two main metal power lead frames and a main metal grounding lead frame respectively mounted in the open chambers of the housing, the main metal power lead frames being spaced from the main metal grounding lead frame at two opposite lateral sides, the main metal power lead frames each comprising a top hook, a back contact portion disposed in contact with the inner contact end of one metal power prong of the back plate, a transverse metal contact clamp formed of a horizontal upper front contact portion and a horizontal lower front contact portion, a side contact portion disposed at one side of the transverse metal contact clamp to form a vertical metal contact clamp, the main metal grounding lead frame comprising a transverse receiving portion, a longitudinal receiving portion disposed below the transverse receiving portion, a back metal contact spring strip disposed in contact with the inner contact end of the metal grounding prong, and a back spring strip; a faceplate covered on a front side of the housing, the faceplate having a set of main grounding terminal holes corresponding to the main metal grounding lead frame, the main grounding terminal holes including two big main grounding terminal holes vertically connected in a line and two small main grounding terminal holes vertically spaced below the big main grounding terminal holes and aligned with the big main grounding terminal holes in a line, and two main power terminal holes arranged in parallel at two sides of the small main grounding terminal slots corresponding to the transverse metal contact clamps and vertical metal contact clamps of the main metal power lead frames; and a back plate fastened to a back side of the housing, the back plate comprising two metal power prongs and a metal grounding prong for connection of an electric outlet, the metal power prongs and metal grounding prong of the back plate each having an inner contact end respectively disposed in contact with the main metal power lead frames and the main grounding lead frame. According to another aspect of the present invention, the main metal power lead frames each further comprise an oblique front metal contact clamp formed of a first oblique front contact portion extended from the side contact portion of the respective main metal power lead frame and a second oblique front contact portion extended from the lower front contact portion of the respective main metal power lead frame, and the faceplate further comprises two oblique power terminal holes corresponding to the oblique front metal contact clamps of the main metal power lead frames to fit an electric plug of Australia/New Zealand specifications. According to still another aspect of the present invention, two supplementary metal power lead frames and a supplementary metal grounding lead frame are provided in the housing to fit an electric plug of South Africa specifications.

### BRIEF DESCRIPTION OF THE DRAWINGS

FIG. 1 is an exploded view of a multipurpose electric adapter according to a first embodiment of the present invention.

FIG. 2 is a front view of the faceplate for the multipurpose electric adapter shown in FIG. 1.

FIG. 3 is a front view of an alternate form of the faceplate for the multipurpose electric adapter according to the present invention.

FIG. 4 is a schematic drawing showing the use of the present invention with an electric plug of South Africa specifications.

FIG. 5 is a schematic drawing showing the use of the present invention with an electric plug of Australia/New Zealand specifications.

FIG. 6 is a schematic drawing showing the use of the present invention with an electric plug of UK specifications.

FIG. 7 is a schematic drawing showing the use of the present invention with an electric plug of US specifications.

FIG. 8 is a schematic drawing showing the use of the present invention with an electric plug of European specifications.

FIG. 9 is an exploded view of a multipurpose electric adapter according to a second embodiment of the present invention.

FIG. 10 is an exploded view of a multipurpose electric adapter according to a third embodiment of the present invention.

FIG. 11 is a sectional assembly view of the multipurpose electric adapter according to the third embodiment of the present invention.

FIG. 12 is another sectional assembly view of the multipurpose electric adapter according to the third embodiment of the present invention.

FIG. 14 is an exploded view of an electric adapter according to the prior art.

FIG. 15 is a sectional assembly view of the electric adapter according to the prior art.

FIG. 16 is another sectional assembly view of the electric adapter according to the prior art.

### DETAILED DESCRIPTION OF THE PREFERRED EMBODIMENT

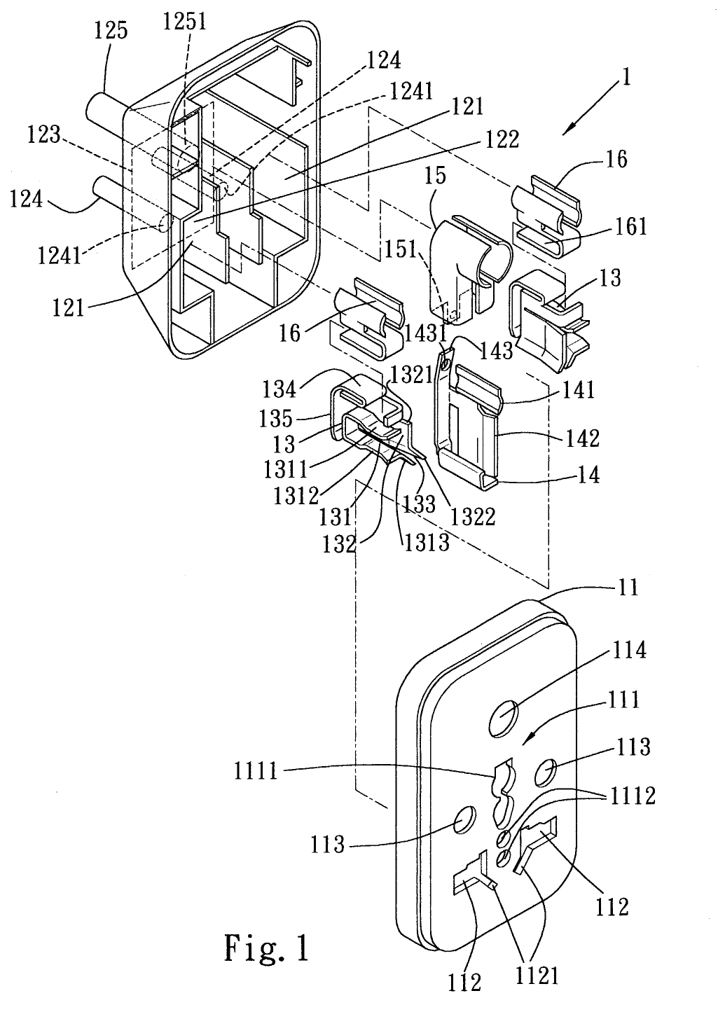

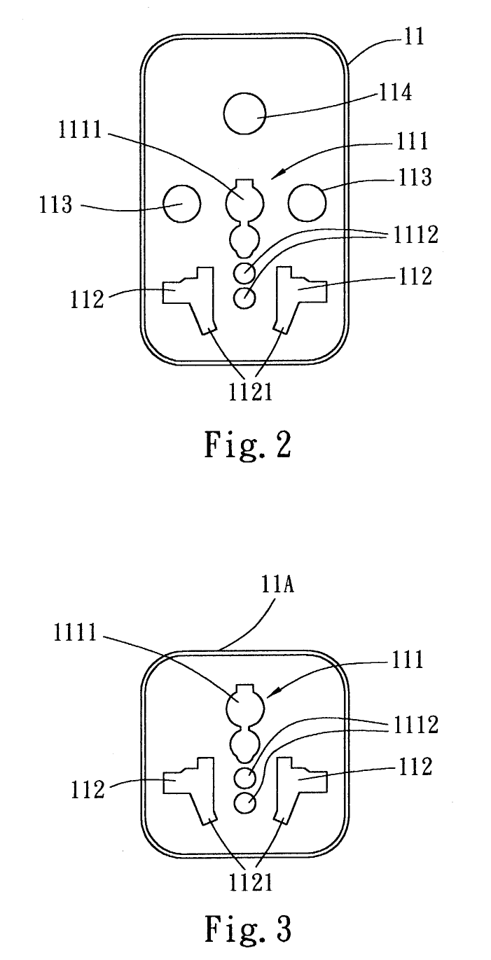

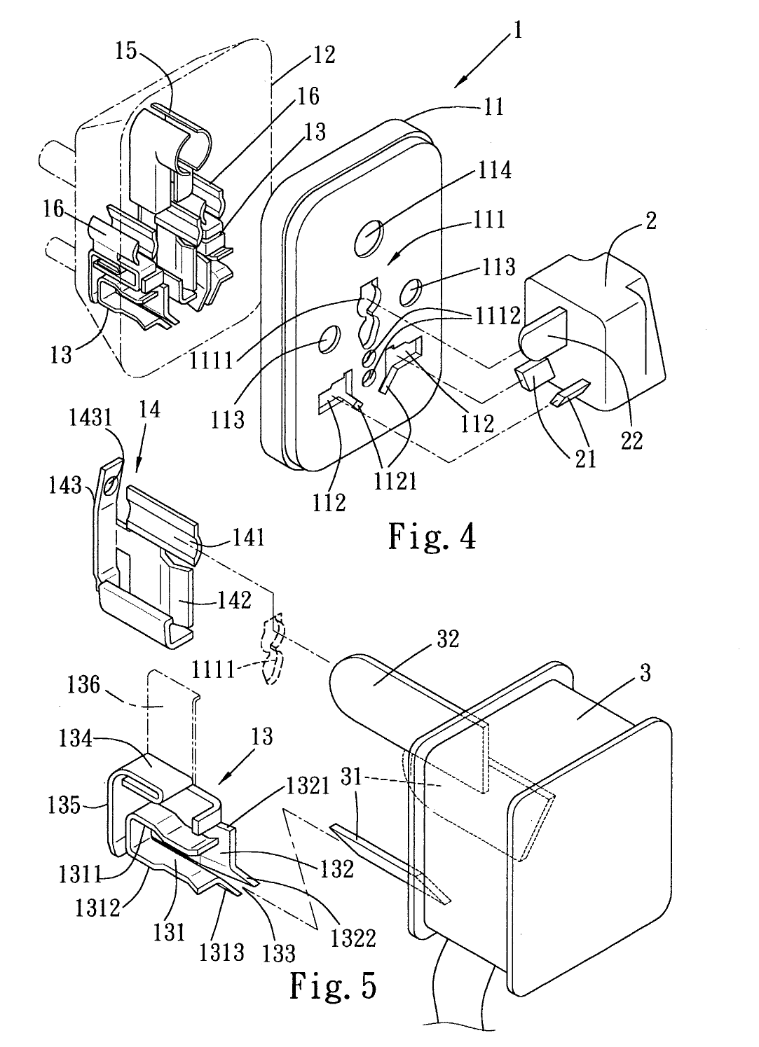

Referring to FIGS. 1, 2, 4, and 5, an electric adapter 1 is shown comprised of a faceplate 11, an electrically insulative housing 12, a back (plug) plate 123, two main metal power lead frames 13, a main metal grounding lead frame 14, two supplementary metal grounding lead frame 15, and two supplementary metal power lead frames 16.

The housing 12 has a plurality of back open chambers 121 and 122 adapted to accommodate the main metal power lead frames 13, the main metal grounding lead frame 14, the supplementary metal grounding lead frame 15, and the supplementary metal power lead frames 16.

The back plate 123 is detachably fastened to the back side of the housing 12, having two metal power prongs 124 and a metal grounding prong 125 for connection of an electric outlet. The prongs 124 and 125 each have an inner contact end 1241 or 1251 respectively suspended in the back open chambers 121 and 122 of the housing 12.

The two main metal power lead frames 13 and the main metal grounding lead frame 14 are respectively mounted in the back open chambers 121 and 122 of the housing 12 near the bottom. The main metal power lead frames 13 are spaced from the main metal grounding lead frame 14 at two opposite lateral sides, each comprising a top hook 134, a back contact portion 135 disposed in contact with the inner contact end 1241 of one metal power prong 124 of the back plate 123, a transverse metal contact clamp 131 formed of a horizontal upper front contact portion 1311 and a horizontal lower front contact portion 1312, a side contact portion 1321 disposed at one side of the transverse metal contact clamp 131 to form a vertical metal contact clamp 132, and an oblique front metal contact clamp 133 formed of a first oblique front contact portion 1322 extended from the side contact portion 1321 and a second oblique front contact portion 1313 extended from the lower front contact portion 1312.

The main metal grounding lead frame 14 comprises a transverse receiving portion 141, a longitudinal receiving portion 142 disposed below the transverse receiving portion 141, a back metal contact spring strip 143 disposed in contact with the inner contact end 1251 of the metal grounding prong 125. The back metal contact spring strip 143 has a mounting hole 1431 in the top free end.

The supplementary metal grounding lead frame 15 is mounted inside the housing 12 above the main metal grounding lead frame 14, having a bottom mounting portion 151 riveted to the mounting hole 1431 of the back metal contact spring strip 143 of the main metal grounding lead frame 14.

The supplementary metal power lead frames 16 are respectively mounted in the housing 12 above the main metal power lead frames 13, each having a bottom hook 161 respectively hooked up with the top hooks 134 of the main metal power lead frames 13.

The faceplate 11 is covered on the housing 12 to close the receiving chambers 121 and 122, having a set of main grounding terminal holes 111 corresponding to the main metal grounding lead frame 14, the main grounding terminal holes 111 including two big main grounding terminal holes 1111 vertically connected in a line and two small main grounding terminal holes 1112 vertically spaced below the big main grounding terminal holes 1111 and aligned with the big main grounding terminal holes 1111 in a line, two main power terminal holes 112 arranged in parallel at two sides of the small main grounding terminal slots 1112 corresponding to the transverse metal contact clamps 131 and vertical metal contact clamps 132 of the main metal power lead frames 13, two oblique power terminal holes 1121 respectively obliquely extended from the main power terminal holes 112 toward each other and spaced from each other at a distance corresponding to the oblique front metal contact clamps 133 of the main metal power lead frames 13, two supplementary power terminal holes 113 equally spaced from the big main grounding terminal holes 1111 at two opposite lateral sides corresponding to the supplementary metal power lead frames 16, and a supplementary grounding terminal hole 114 spaced above the big main grounding terminal holes 1111 corresponding to the supplementary metal grounding lead frame 15.

Referring to FIG. 5 and FIG. 1 again, the multipurpose electric adapter 1 can be used with an electric plug 3 of Australia/New Zealand specifications. When fastening the electric plug 3 to the multipurpose electric adapter 1, the grounding prong 32 of the electric plug 3 is inserted through the top big main grounding terminal hole 1111 into the transverse receiving portion 141 of the main metal grounding lead frame 14, and the two power prongs 31 of the electric plug 3 are respectively inserted through the oblique power terminal holes 1121 into the oblique front metal contact clamps 133 of the main metal power lead frames 13.

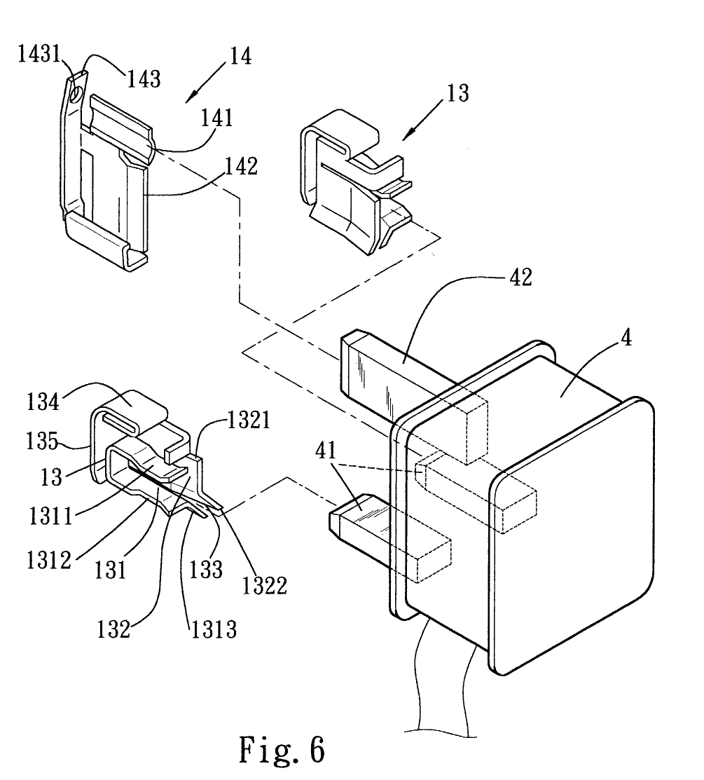

Referring to FIG. 6 and FIG. 1 again, the multipurpose electric adapter 1 can be used with an electric plug 4 of UK specifications. When fastening the electric plug 4 to the multipurpose electric adapter 1, the grounding prong 42 of the electric plug 4 is inserted through the big main grounding terminal holes 1111 into the transverse receiving portion 141 of the main metal grounding lead frame 14, and the two power prongs 41 of the electric plug 4 are respectively inserted through the main power terminal holes 112 into the transverse metal contact clamps 131 of the main metal power lead frames 13.

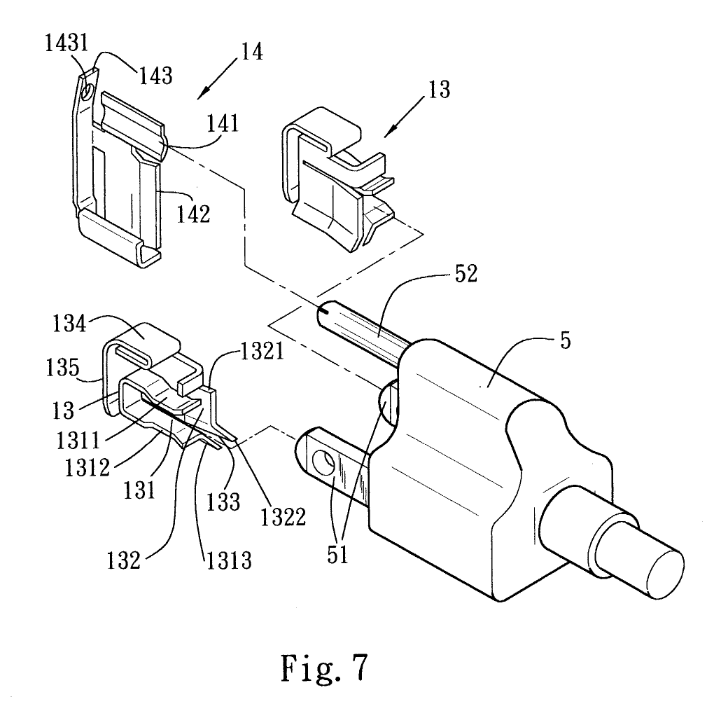

Referring to FIG. 7 and FIG. 1 again, the multipurpose electric adapter 1 can be used with an electric plug 5 of US specifications. When fastening the electric plug 5 to the multipurpose electric adapter 1, the grounding prong 52 of the electric plug 4 is inserted through the top big main grounding terminal hole 1111 into the transverse receiving portion 141 of the main metal grounding lead frame 14, and the two power prongs 51 of the electric plug 4 are respectively inserted through the main power terminal holes 112 into the vertical metal contact clamps 132 of the main metal power lead frames 13.

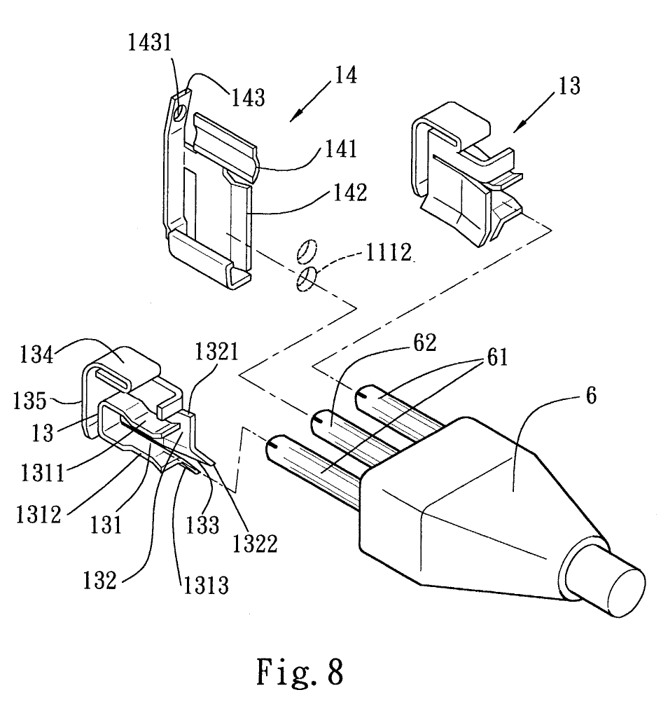

Referring to FIG. 8 and FIG. 1 again, the multipurpose electric adapter 1 can be used with an electric plug 6 of European specifications. When fastening the electric plug 6 to the multipurpose electric adapter 1, the grounding prong 62 of the electric plug 6 is inserted through the bottom small main grounding terminal holes 1112 into the longitudinal receiving portion 142 of the main metal grounding lead frame 14, and the two power prongs 61 of the electric plug 6 are respectively inserted through the main power terminal holes 112 into the transverse metal contact clamps 131 of the main metal power lead frames 13.

Further, the supplementary metal grounding lead frame 15 and the supplementary metal power lead frames 16 match with the supplementary power terminal holes 113 and supplementary grounding terminal hole 114 of the faceplate 11 to receive an electric plug of South Africa specifications.

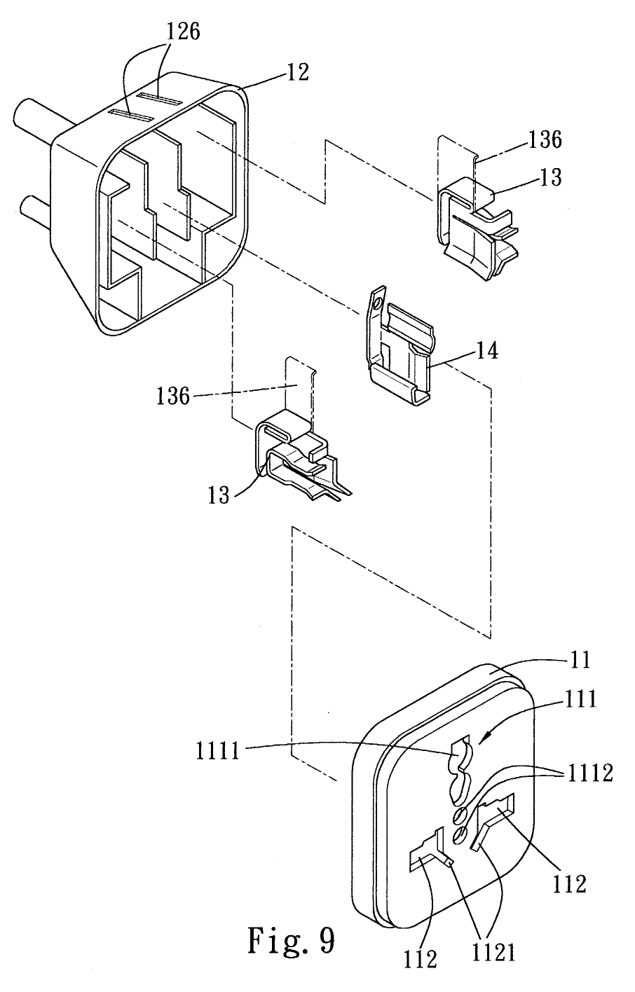

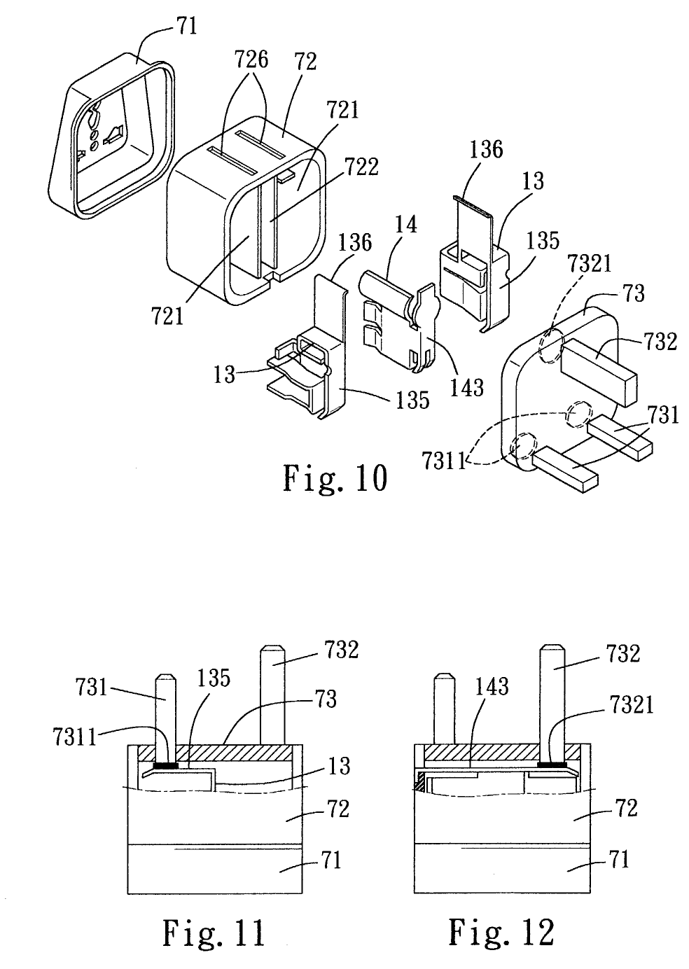

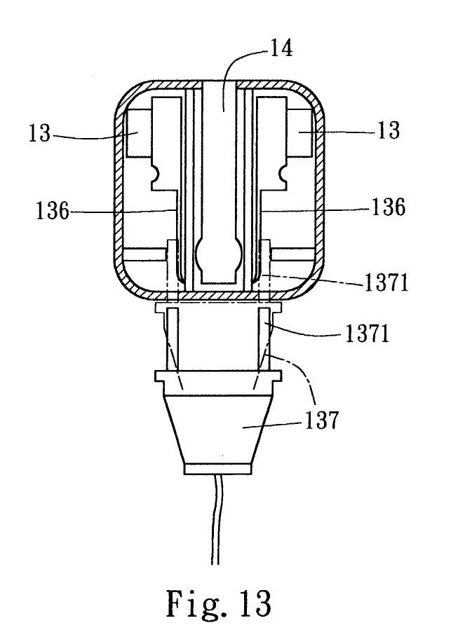

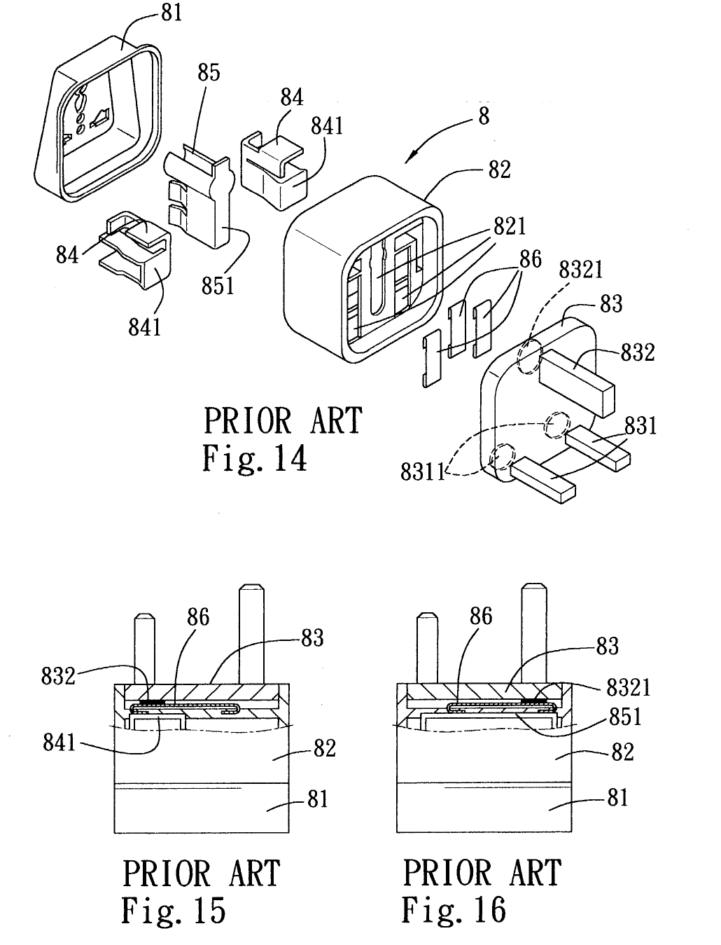

FIG. 9 is an exploded view of a multipurpose electric adapter according to the second embodiment of the present invention. As illustrated, the multipurpose electric adapter is comprised of a housing 12, a main metal grounding lead frame 14 and two main metal power lead frames 13 respectively mounted in the housing 12 (the main metal grounding lead frame 14 and the main metal power lead frames 13 are same as that shown in FIG. 1), and a faceplate 11 covered on the housing 12. The faceplate 11 has a set of main grounding terminal holes 111 corresponding to the main metal grounding lead frame 14, the main grounding terminal holes 111 including two big main grounding terminal holes 1111 vertically connected in a line and two small main grounding terminal holes 1112 vertically spaced below the big main grounding terminal holes 1111 and aligned with the big main grounding terminal holes 1111 in a line, two main power terminal holes 112 arranged in parallel at two sides of the small main grounding terminal slots 1112 corresponding to the transverse metal contact clamps and vertical metal contact clamps of the main metal power lead frames 13, and two oblique power terminal holes 1121 respectively obliquely extended from the main power terminal holes 112 toward each other and spaced from each other at a distance corresponding to the oblique front metal contact clamps of the main metal power lead frames 13. This embodiment eliminates the design for South Africa specifications. Further, the main metal power lead frames 13 may be made having a respective vertical contact portion 136 respectively aimed at a respective insertion hole 126 in the peripheral wall of the housing 12 to receive an electric plug without grounding prong. The faceplate 11A shown in FIG. 3 may be used to substitute for the faceplate 11 shown in FIG. 9.

FIGS. 10˜12 show a multipurpose electric adapter according to the third embodiment of the present invention. According to this embodiment, the multipurpose electric adapter is comprised of a housing 72, two main metal power lead frames 13 and a main metal grounding lead frame 14 respectively mounted in respective open chambers 721 and 722 in the housing 12, a faceplate 71 covered on the front side of the housing 72, and a back (plug) plate 73 covered on the back side of the housing 72. The back plate 73 comprises two metal power blades 731 and a grounding prong 732 perpendicularly outwardly extended from the outer side. The metal power blades 731 and the grounding prong 732 have a respective inner contact end 7311 or 7321 respectively forced into contact with respective contact portions 135 and 143 of the lead frames 13 and 14. Further, the main metal power lead frames 13 each have a vertical contact portion 136 respectively aimed at a respective insertion hole 726 in the peripheral wall of the housing 72.

A prototype of multipurpose electric adapter has been constructed with the features of FIGS. 1˜13. The multipurpose electric adapter functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A multipurpose electric adapter comprising:
an electrically insulative housing, said housing comprising a plurality of open chambers;
two main metal power lead frames and a main metal grounding lead frame respectively mounted in the open chambers of said housing, said main metal power lead frames being spaced from said main metal grounding lead frame at two opposite lateral sides, said main metal power lead frames each comprising a top hook, a back contact portion disposed in contact with the inner contact end of one metal power prong of said back plate, a transverse metal contact clamp formed of a horizontal upper front contact portion and a horizontal lower front contact portion, a side contact portion disposed at one side of said transverse metal contact clamp to form a vertical metal contact clamp, said main metal grounding lead frame comprising a transverse receiving portion, a longitudinal receiving portion disposed below said transverse receiving portion, a back metal contact spring strip disposed in contact with the inner contact end of said metal grounding prong, and a back spring strip;
a faceplate covered on a front side of said housing, said faceplate having a set of main grounding terminal holes corresponding to said main metal grounding lead frame, said main grounding terminal holes including two big main grounding terminal holes vertically connected in a line and two small main grounding terminal holes vertically spaced below said big main grounding terminal holes and aligned with said big main grounding terminal holes in a line, and two main power terminal holes arranged in parallel at two sides of the small main grounding terminal slots corresponding to the transverse metal contact clamps and vertical metal contact clamps of said main metal power lead frames; and
a back plate fastened to a back side of said housing, said back plate comprising two metal power prongs and a metal grounding prong for connection of an electric outlet, the metal power prongs and metal grounding prong of said back plate each having an inner contact end respectively disposed in contact with said main metal power lead frames and said main grounding lead frame.

2. The multipurpose electric adapter as claimed in claim 1, wherein said main metal power lead frames each further comprise an oblique front metal contact clamp formed of a first oblique front contact portion extended from the side contact portion of the respective main metal power lead frame and a second oblique front contact portion extended from the lower front contact portion of the respective main metal power lead frame; said faceplate further comprises two oblique power terminal holes respectively obliquely extended from said main power terminal holes toward each other and spaced from each other at a distance corresponding to the oblique front metal contact clamps of said main metal power lead frames.

3. The multipurpose electric adapter as claimed in claim 1, wherein said housing further comprises two insertion slots for receiving the two metal prongs of an electric plug; said main metal power lead frames each further comprise a contact portion respectively aimed at the insertion slots of said housing and adapted to receive the two metal prongs of an electric plug.

4. The multipurpose electric adapter as claimed in claim 1, further comprising two supplementary metal power lead frames mounted inside said housing and respectively connected to said main metal power lead frames at a top side, said supplementary metal power lead frames each having a bottom hook respectively hooked up with the top hooks of said main metal power lead frames, and a supplementary metal grounding lead frame mounted in said housing and connected to the main metal grounding lead frame at a top side for use with said supplementary metal power lead frames to receive an electric plug of South Africa specifications, said supplementary metal grounding lead frame having bottom mounting means riveted to said back spring strip of said main metal grounding lead frame.

5. The multipurpose electric adapter as claimed in claim 4, wherein said faceplate further comprises two supplementary power terminal holes equally spaced from said big main grounding terminal holes at two opposite lateral sides corresponding to said supplementary metal power lead frames, and a supplementary grounding terminal hole spaced above said big main grounding terminal holes corresponding to said supplementary metal grounding lead frame.

6. The multipurpose electric adapter as claimed in claim 1, wherein said housing is formed integral with an extension cable.
